(19) United States
(12) Patent Application Publication
(10) Pub. No.: US 2009/0002355 A1
(43) Pub. Date: Jan. 1, 2009

(54) Active Matrix Liquid Crystal Display Device and Method of Driving the Same

(75) Inventor: Akihiro Iwatsu, Tokyo (JP)

Correspondence Address: BIRCH STEWART KOLASCH & BIRCH, PO BOX 747, FALLS CHURCH, VA, 22040-0747, US

(73) Assignee: TPO Hong Kong Holding Limited, Shatin (HK)

(21) Appl. No.: 11/663,505

(22) PCT Filed: Sep. 22, 2005
(86) PCT No.: PCT/IB2005/053117

§ 371 Date: Jul. 1, 2008

(30) Foreign Application Priority Data
Sep. 24, 2004 (JP) 2004-277831
Apr. 28, 2005 (JP) 2005-132943

(51) Int. Cl. G09G 5/00; G09G 3/36

(52) U.S. Cl. 345/205; 345/90

(57) ABSTRACT

The present invention is directed to an a.c. driven active matrix liquid crystal display device capable of inhibiting the aforementioned artifact of stripes as well as saving the power consumption, and a method of driving such a device. A selection switch SW controlled by a column selection circuit 50 enables selection of picture signal lines Sb to be connected to a picture signal source 40 by skipping, and since the picture signal lines are divided in two groups such as a group of odd numbered ones and the other group of even numbered ones so that the connection sequence of the groups of them are varied from one of two consecutive periods to another, vivid stripes are prevented from coming up simply upon the connection to the picture signal lines related with any specific color, thereby enhancing the quality of the resultant picture displayed. A plurality of picture signal lines which are selected by a plurality of picture signal selecting circuits may be arranged adjacent to one another.

### TECHNICAL FIELD

The present invention relates to an active matrix liquid crystal display device and a method for driving the same.

### BACKGROUND ART

An active matrix liquid crystal display device, in which each of liquid crystal display pixels arranged in matrix form has its own controlling thin film semiconductor element, is broadly used for various applications such as personal computers.

Many of such matrix liquid crystal display devices employ an alternating current driving method. According to this driving method, the polarity of driving voltage applied to the liquid crystal is reversed for every frame, which is a countermeasure for some kinds of deterioration of a reduced resistivity due to the liquid crystal material composite denatured during the considerably long operation with the d.c. voltage supply. The more specified fundamental operation in such driving method is disclosed in a Non-Patent Document 1 listed below.

In such an a.c. driving method, the polarity reversal frequency of the driving voltage, once reaching a half of the frame frequency, typically causes flickering, but by spatially and time-varyingly averaging the polarity reversal, the basic wave components of optically responded ripples can be made the frame frequency or even higher so as to avoid the flickering (the visible flickering). More Particularly, an adjacent pixel to any single pixel (or an adjacent column or row of pixels to any set of pixels in series) is reversed in the polarity of the driving voltage applied thereto, and further, the corresponding pixels or the corresponding set of the pixels are made to assume alternately inverted polarities between any pair of consecutive frames.

In the aforementioned prior art, a polarity inverting rate of the driving voltage is considerably high, and this may generally cause the driver circuit to consume increased power. An improved prior technology for overcoming such a problem, has been designed to save the power consumption while the a.c. driving is maintained, which is also in the list below as Patent Document 1 filed by the applicant of this application. This driving method is a driving method to a.c. drive pixels arranged in matrix form, in which a plurality of row electrodes which extend horizontally in the picture to be displayed are selectively activated in a horizontal scanning period, and a plurality of column electrodes which extend vertically in the picture are provided pixel voltage corresponding to the picture and the horizontal scanning period by reversing its polarity frame by frame, resulting in the pixel voltages developing alternating polarities spatially and in the vertical direction in the picture of the frame period. By this method, a timing of applying a group of pixel voltages to one row of electrodes and another timing of applying another group of pixel voltages to another row of electrodes which are expected to have the same polarity as the one row are generated in time sequence, and in response to the supply timings of the pixel voltages, the corresponding row electrode is made active.

In this way, the example in Patent Document 1 attains a reduction of the power consumption by reducing the polarity inverting rate of the pixel voltage along time axis with the dimensional polarity reversal pattern of the pixel voltage in the field being unchanged from the prior art a.c. driving pattern.

In such a prior art, however, if a user desires, for example, a screen full of even dark gray monochromatic representation, there sometimes arises an inadvertently awkward phenomenon called ‘line-to-line artifact’ where relatively bright and dark horizontal stripes are repetitively alternated to fill the whole field.

The disclosure in Patent Document 2 in the list gives a solution to the poor representation with stripes that are caused in a situation where a plurality of data lines (multiples of two in number) are to be gathered in one to connect to data line driver circuits having a smaller number of data lines. This improvement includes a shift means, upon each scanning, capable of permuting a set of n data lines that are on standby and are to be sequentially connected to output signal lines of the data line driver circuits.

In addition, well known in the prior art is an driving apparatus that uses multiplexers and supplies picture signals to picture signal lines (picture buses) on the timesharing basis so as to drive the liquid crystal display device.

FIG. 12 shows an exemplary practical manner of using a plurality of multiplexer circuits to control picture signal lines C1 to C6 where there are two of the multiplexer circuits MPXA and MPXB adjacent to each other, respectively having three switches, SW1 to SW3 and SW4 to SW6 which enable sequential selections among the picture signal lines C1 to C6 connected to the multiplexers. Any picture signal line connected to one of the multiplexers is activated simultaneous with its counterpart signal line connected to the other; for instance, the switches SW1 and SW4 are simultaneously turned on and off, and two of picture signal sources SS1 and SS2 produce signals to their respective correlated picture signal lines in such a manner that picture signal data Data1 from SS1 is supplied to the picture signal line C1 while simultaneously picture signal data Data2 from SS2 is supplied to the picture signal line C4.

In this way, this type of the prior art liquid crystal display device has the multiplexers arranged adjacent to each other, and for the purpose of simplification of a timing circuit in liquid crystal display driver circuit, the order of selecting some among the picture signal lines keeps consistently fixed so as to avoid duplexity of any picture signal line. Additionally, a picture signal amplifier in the liquid crystal display driver circuit includes a reference voltage circuit that produces a predetermined voltage or a predetermined voltage depending upon polarity.

The configuration as mentioned above has an advantage to reduce the number of output terminals from the driver IC and the area of the same, and thus, the resultant driver IC can attain an advantage of cost reduction.

### LIST OF CITED REFERENCES

Non-Patent Document 1: Shoichi Matsumoto, Liquid Crystal Display Technology—Active Matrix LCD (2nd Edition, Sangyo Tosho Shuppan K.K., Nov. 14, 1997) 69-74;
Patent Document 1: Official Gazette of Japanese Patent Laid-open Publication No. 2003-11464 (especially see Claims, FIGS. 2 and 3, and Paragraph Nos. 0031 to 0059); and
Patent Document 2: Official Gazette of Japanese Patent Laid-open Publication No. 2003-58119.

### DISCLOSURE OF INVENTION

### Technical Problem

In order to overcome the aforementioned disadvantages in the prior art, the applicant of the present invention has provided a solution that in applying a signal from a single signal source to more than one picture signal lines, the picture signal lines are divided into two groups, and the groups are selected in a varied sequence from first cycle to the second cycle.

While sequentially selecting the adjacent picture signal lines one from another, however, a variation in voltage level in the adjacent picture signal line(s) affects the voltage level in the reference picture signal line, and even a minor variation, when accumulated, may result in an adverse artifact that, for instance, red stripes are observed although a gray monochromatic representation is desired in some active matrix color liquid crystal display device having red, blue, and green secondary pixels.

The above-mentioned stripes are developed since the existing potential at the current picture signal line and the pixels connected thereto is deviated from a rated level because of the coupling to the parasitic capacitance upon supplying the adjacent picture signal line(s) with voltage from the signal source although the reference picture signal line and the associated pixels are in high impedance state while the pixel switch is closed and the reference picture signal line is disconnected from the signal source. Such coupling to the parasitic capacitance affects the picture signal lines selected the first and the last and the remaining ones differently from one another although they are connected to the common switch in the circuitry, and as a result, three different levels of the actual pixel voltage are developed, being deviated from the rated voltage, which causes the aforementioned artifact and/or the undesired tone.

Additionally, in driving any set of the adjacent picture signal lines in reverse polarity to each other, the signal source needs to supply voltage to each of the picture signal lines so as to make them assume alternately inverted polarity, and this also increases the deviation from the rated voltage which results in the artifact getting worse in addition to an increase of the power consumption.

With such a prior art multiplexer configuration, however, the picture buses in any single circuit must be supplied with signals of the same polarity. This is because it must be avoided to further deteriorate the resultant displayed picture due to fixing pixels at a level of voltage considerably deviated from the desired voltage level, which is resulted from an increase in electric power as a result of quick polarity reversing in the picture signal supply circuit and also from greater power loss as a result of capacity coupling between the buses and the pixels in comparison with the circuit featuring homogenized polarity of signals.

Such loss is caused by continuously selecting scan lines during selective driving of all the buses in the selected rows. All the busses and pixels turned in floating conditions after selecting the picture buses in some fixed order are affected and varied in potential from the fixed level in the amount of the divided capacity as a result of the capacity coupling when an adjacent one to any bus is selected and varied in potential. In this way, such potential variation of the adjacent bus twice affects the first selected bus and once affects all the remaining buses but the one selected last over a single cycle of the scanning.

Also, in the aforementioned prior art liquid crystal display apparatus where the multiplexers are used to supply the picture signal lines with picture signals on the timesharing basis, the scan lines are continuously selected while all the picture signal lines are being activated, and the buses and the pixels turned in floating conditions after the selections are affected and varied in potential from the fixed level by the divided capacity as a result of the capacity coupling when the adjacent one to any bus is selected and varied in potential.

In this way, such potential variation of the adjacent bus twice affects the first selected bus and once affects all the remaining buses but the one selected last over a single cycle of the scanning. Consequently, the resultant voltage is deviated from the targeted pixel voltage level, and this appears as inadvertently varied color or brightness.

Accordingly, it is an object of the present invention to provide an a.c. driven active matrix liquid crystal display device capable of inhibiting the aforementioned artifact of stripes as well as saving the power consumption, and a method of driving such a device.

### Technical Solution

According to one aspect of the present invention, there is provided an active matrix liquid crystal display device having a plurality of picture signal lines and a plurality of scan lines orthogonal to them, and a plurality of pixels arranged in matrix form and connected to the picture signal lines by switching elements intervening between them, comprising:

selection switches provided in the plurality of the picture signal lines on a substrate constituting a display device;
a plurality of picture signal sources smaller than the picture signal lines in number; and
a selective control device capable of selectively opening/closing the selection switches to skip connection with any picture signal line adjacent to each other, in the case that the plurality of picture signal sources are shared by the plurality of picture signal lines.

According to another aspect of the present invention, there is provided a method of driving an active matrix liquid crystal display device which is comprised of an active matrix liquid crystal display panel having a plurality of picture signal lines and a plurality of scan lines orthogonal to them, and a plurality of pixels in matrix and connected to the lines by switching elements intervening between them; selection switches provided in the plurality of the picture signal lines on a substrate constituting a display device; and a plurality of picture signal source smaller than the picture signal lines in number;

the method comprising the step of:
selectively opening/closing the selection switches to skip connection with any picture signal line adjacent to each other, thereby permitting the picture signal lines to share the picture signal sources smaller in number.

According to further aspect of the present invention, there is provided an active matrix liquid crystal display apparatus comprised of a plurality of picture signal lines and a plurality of scan lines orthogonal to them, and a plurality of pixels in matrix and connected to the lines by switching elements intervening between them, comprising selection switches respectively provided with the plurality of the picture signal lines on a substrate constituting a display device;

a plurality of picture signal source producing picture signals and smaller than the picture signal lines in number; and
a plurality of picture signal selecting circuits selecting a single picture signal line in one of groups of the picture signal lines and supplying picture signals from the picture signal sources on the time-sharing basis to the selected picture signal line;
The picture signal lines, which are simultaneously selected respectively by the picture signal selecting circuits, being arranged adjacent to one another.

According to still further aspect of the present invention, there is provided in a method of driving an active matrix liquid crystal display apparatus comprised of a plurality of picture signal lines and a plurality of scan lines orthogonal to them, an active matrix liquid crystal display panel including a plurality of pixels arranged in matrix from and connected to the lines by switching elements intervening between them, selection switches respectively provided with the plurality of the picture signal lines on a substrate constituting a display device and a plurality of picture signal sources producing picture signals and smaller than the picture signal lines in number, when the plurality of picture signal sources are shared among the plurality of the picture signal lines, corresponding selecting switches in adjacent picture signal lines to which the picture signal are provided by the picture signal sources are simultaneously selected.

### ADVANTAGEOUS EFFECTS

In the active matrix liquid crystal device according to the present invention, a selection switch enables alternate ones of the picture signal lines to be connected to the signal source, and since the signal lines are divided in two groups such as a group of odd numbered ones and the other group of even numbered ones so that the connection sequence of the groups of them are varied from one of two consecutive periods to another, vivid stripes are prevented from coming up simply upon the connection to the picture signal lines related with any specific color, thereby enhancing the quality of the resultant picture displayed.

The similar effect can be attained by providing a plurality of picture signal lines adjacent to one another so that a plurality of picture signal selecting circuits synchronously select the picture signal lines.

When the adjacent picture signal lines are supplied with signals of the reversed polarities to each other, the method according to the present invention needs the switching of the polarity at the picture signal lines only twice during the single horizontal scan period, compared with the operation relying the sequential selection of the picture signal lines, and this effectively saves the power consumption.

### DESCRIPTION OF DRAWINGS

FIG. 1 is a schematic block diagram showing a construction of an exemplary liquid crystal display device 10 associated with a matrix driver circuit according to the present invention;

FIG. 2 is a timing chart illustrating a timing signal from a timing control circuit, and output signals from row and column selection circuits altogether;

FIG. 3 is a circuit diagram showing row selection signals respectively used to chose selection switches to selectively connect a column driver circuit to column electrodes;

FIG. 4 is a timing chart showing the column electrodes activated, based upon the basic technology according to the present invention;

FIG. 5 is a graph illustrating level shifts in each of the six column electrodes;

FIG. 6 is a timing chart showing an example of the control of the column selection signals according to the present invention;

FIG. 7 is a graph illustrating a phase of the polarity reversal;

FIG. 8 is a graph illustrating another phase of the polarity reversal;

FIG. 9 is a graph illustrating a potential variation at the six column electrodes under the control through the column selection signal in the embodiment according to the present invention; and

FIGS. 10 and 11 are graphs illustrating the operation in applications of the present invention.

FIG. 12 is a schematic circuit diagram illustrating an example of the control of the picture signal lines by means of a plurality of prior art multiplexer circuits;

FIG. 13 is a schematic block diagram showing a matrix driver circuit of a liquid crystal display apparatus 15 according to the present invention;

FIG. 14 is a schematic circuit diagram showing part used to control the picture signal lines by means of two of the Multiplexer circuits in the embodiment shown in FIG. 13;

FIG. 15 depicts a timing chart illustrating various timing outputs together, including outputs from a timing control circuit and output signals from column and row selections circuits in the liquid crystal display apparatus 15;

FIG. 16 is a schematic diagram showing another embodiment of the present invention; and

FIG. 17 is a schematic diagram showing a simplified embodiment than that shown in FIG. 16.

### BEST MODE

Embodiments of the present invention will be described in detail in conjunction with the accompanying drawings.

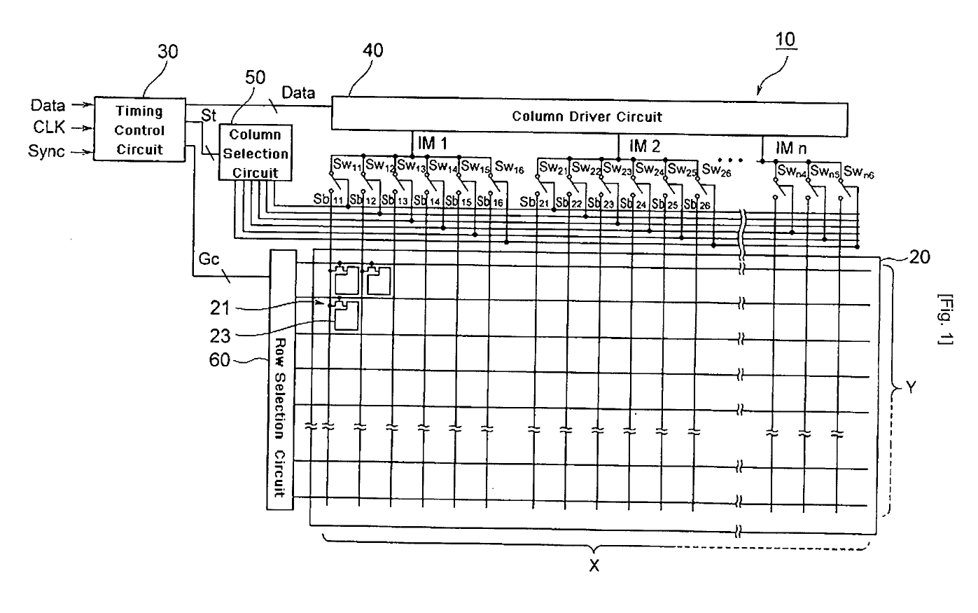

FIG. 1 is a schematic block diagram showing an exemplary liquid crystal display device associated with a matrix driver circuit 10 according to one embodiment of the present invention.

As can be seen in FIG. 1, the matrix driver circuit 10 has a display panel 20 for an active matrix liquid crystal display (LCD) device which includes pixels arranged in matrix form within an area defined as a display field, and thin film transistors (TFTs) 21 of field effect transistors and pixel driving elements. The display panel 20 is activated by a driver circuit detailed below.

In the display panel 20, the TFTs 21 are arranged in matrix form of Y rows and X columns, and each TFT 21 has its gate electrode connected to a gate bus line (referred to as ‘gate line’ hereinafter) juxtaposed with each row of the TFTs and traversing the display field in the horizontal direction, and has its source electrode connected to a source bus line (abbreviated as ‘source line’ hereinafter) juxtaposed with each column of the TFTs and extending longitudinally across the display field. The TFTs 21 also have their respective drain electrodes connected to pixel electrodes 23 individually.

The display panel 20 provides a common electrode opposed to and spaced from the pixel electrodes 23, and liquid crystal is confined in the clearance between the common electrode and the pixel electrodes 23. Such a configuration is well known in the art, and therefore, omitted from the drawings.

The liquid crystal display device 10 is associated with driver circuits of a timing control circuit 30, a column driver circuit 40 controlled by the same, a column selection circuit 50, and a row selection circuit 60.

The timing control circuit 30 receives image data signals ‘data’ for respective colors, Red (R), Green (G), and Blue (B), clock signals CLK, and synchronization signals containing both horizontal and vertical synchronization signals from signal supply means (not shown), and then transfer the image data signals to the column driver circuit 40 and produces a latch signal Sₜ for synchronously driving the column selection circuit 50 and a control signal G_{c} for controlling the row selection circuit 60, respectively. The timing control circuit 30 also generates a voltage signal V_{com} that is supplied to the common electrode 25 in the display panel 20.

The column driver circuit 40 receives the image data signal from the timing control circuit 30 to apply it to the picture signal lines. In this embodiment, six columns of the pixels are regarded as one set that are connected to the picture signal lines Sb₁₁ to Sb₁₆, respectively, with selection switches intervening between them. Specifically, the first column connected to the picture signal line Sb₁₁ is connected to the common picture signal line IM1 via a switch SW₁₁, the second column connected to the picture signal line Sb₁₂ is connected to the common picture signal line IM1 via a switch SW₁₂, and repeating similarly, and the sixth column connected to the picture signal line Sb₁₆ is connected to the common picture signal line IM1 via a switch SW₁₆. Similarly, the second set starts with the seventh column of the pixels. The seventh column connected to the picture signal line Sb₂₁ is connected to the common picture signal line IM2. Repeating similarly, the twelfth column is connected to the common picture signal line IM2 via a switch SW₂₆. Further similarly, the succeeding sets, each consisting of six columns of the pixels, are provided with the switches, and eventually, the final n-th set are provided with the switches SWₙ₁ to SWₙ₆ (n is an integer).

The column selection circuit 50 controls opening/closing the aforementioned groups of the switches SW respectively provided for the sets of the six picture signal lines. Specifically, upon receiving the latch signal Sₜ from the timing control circuit 30, the column selection circuit 50 divides a single period into six sub-periods to sequentially produce signals to six output lines for the sub-periods separately. The six output lines are used to control the switches provided for the set of the six columns of the pixels. For instance, the first output line is dedicated to the first switches, SW₁₁, SW₂₁, . . . , in the switch groups, the second output line is dedicated to the second switches, SW₁₂, SW₂₂, . . . , in the switch groups, and so forth.

In response to the control signal G_{c} received from the circuit 30, the row selection circuit 60 selectively applies a high voltage to the bus lines to selectively activate the gate lines in the display panel 20, for example. Any gate bus line activated in this manner turns the corresponding TFTs on so as to enable source signals applied to the current series of TFTs to simultaneously activate all of these TFTs in one line. In this way, the row of the pixels corresponding to the activated gate line are optically modulated simultaneously in response to a series of pixel data of one line.

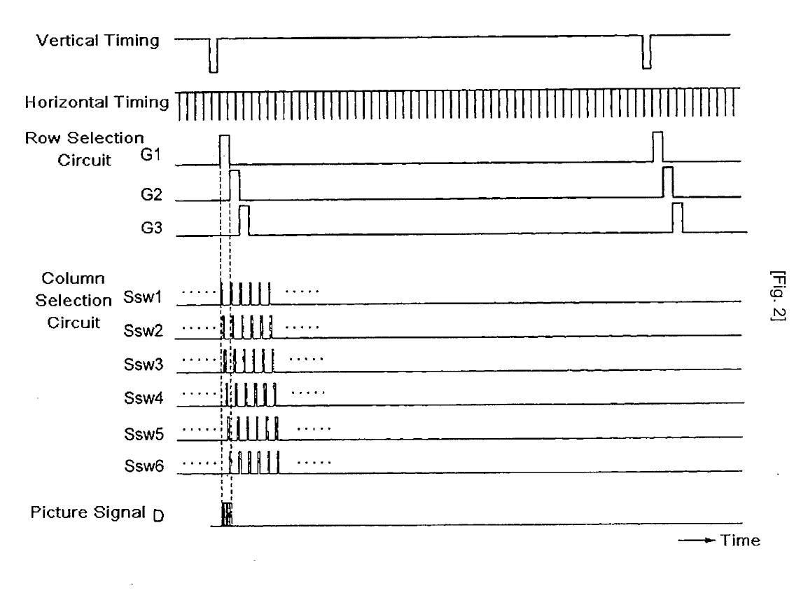

FIG. 2 is a timing chart that provides the concurrent representations of the output timing of the timing control circuit 30 and the output signals from the column and row selection circuits 50 and 60 and the like.

The timing control circuit generates horizontal timing clock signals corresponding to scan lines between two consecutive vertical timing signals that indicate the commencement of a new frame in the field. An interval from the two consecutive horizontal timing signals is designated by a period of 1H during which the timing control circuit 30 and the column driver circuit 40 transfer a picture signal D to the common picture signal lines IM1, IM2, . . . . The column driver circuit 40 includes a digital-analog converter dedicated to each of the image data signals, R, G and B, and the image data signals of the respective colors are analog-converted for every horizontal scan period, so that a set of pixel signals (comprehensively referred to as ‘picture signal’ herein) are produced for each color, carrying a cluster of pixel data to be displayed during the single horizontal scan period (i.e., a single line of the pixel data in series).

On the other hand, in synchronization with the horizontal timing signals, the row selection circuit 60 produces row selection signals G1, G2, G3, and so forth, and the signals corresponding to the columns of the pixels permit the TFTs 21 in the selected columns to turn on.

The column selection circuit 50 produces column selection signals S_{sw1} to S_{sw6}, which sequentially turn on the group of the switches SW dedicated to the set of the six columns of the pixels in the predetermined order. This permits every six TFTs in the identical row to be activated simultaneous with one another, thereby simultaneously carrying out optical modulation of the pixels activated by the corresponding picture signal lines S_{b}.

As a consequence, the rows selected at each horizontal timing are activated and the column selection signals sequentially turn the selection switches on, and hence, the TFTs in the corresponding column are turned on by the picture signal lines. The level of the picture signals applied to the TFTs in their ON-state is used as the reference the determine how much the TFTs should be activated to be sufficient to the image data given to display, and resultantly, the desired level of potential is applied to the pixel electrode 23 through the drain electrodes of those ON-state transistors. The electric field of a strength determined by the difference between the potential at the pixel electrodes and the voltage level applied the common electrode (not shown) effectively controls an orientation of the liquid crystal medium on the basis of one pixel electrode at a time. This manner enables the liquid crystal to modulate backlight irradiated from the back light system (not shown) and front light incident on the display device from the outside, depending upon the pixel data of each pixel. Operations of the liquid crystal display device are well known in the art, and therefore, the further explanation about them is omitted herein.

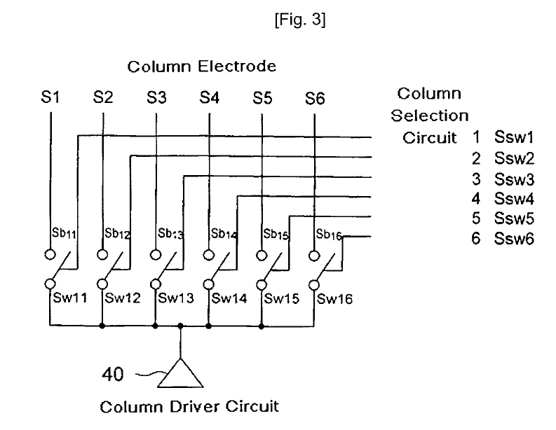

Then, the operation of the driver circuit 10 will be described. Before unique operations of the embodiment, an example of the operation based upon the fundamental technology of this embodiment will be outlined with reference to FIGS. 3 to 5.

FIG. 3 is a circuit diagram showing the components that apply the column selection signals S_{sw1} to S_{sw6} to select the selection switches SW₁₁ to SW₁₆ and permit the column driver circuit 40 to use the picture signal lines S_{b11} to S_{b16} for selective applications of the column driving signals S₁ to S₆ to the desired column electrode(s), which have been described in conjunction with FIG. 1, and for the convenience of recognition, FIG. 3 is depicted upside down from the FIG. 1.

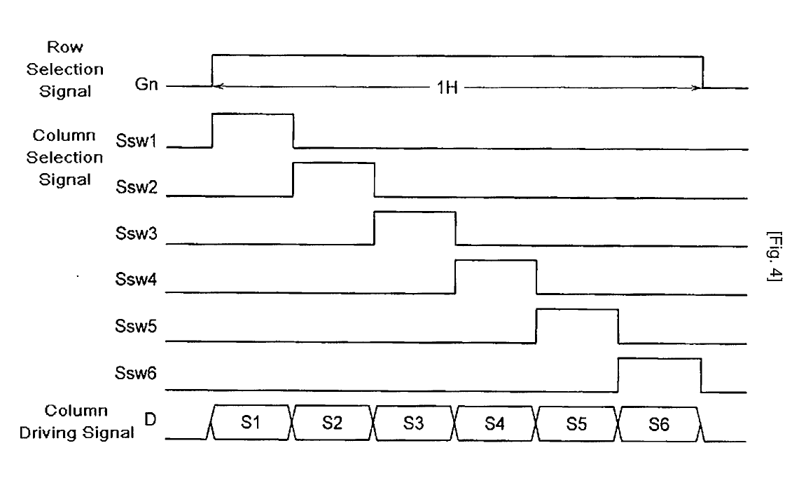

FIG. 4 shows the column electrodes driven by the fundamental technology of this embodiment. During the horizontal scan period (1H) equivalent to a single frame, the row selection signal Gₙ is retained in High state, and the period is divided into six sub-periods so that the column selection signals S_{sw1} to S_{sw6} are produced during the sub-periods to sequentially turn to High state one after another. Also, in response to the column selection signals S_{sw1} to S_{sw6}, the column driving signals S₁ to S₆ are transferred to the picture signal lines.

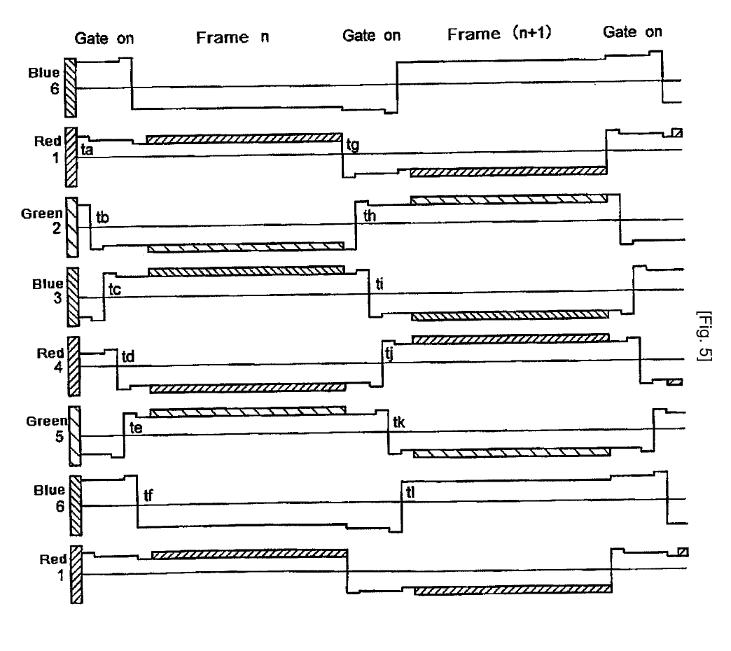

FIG. 5 is a graph illustrating the varying level at the six picture signal lines, Red 1 to Blue 6, namely, a couple of them for each of three colors, over two consecutive frames.

In selecting the column electrodes in the frame (n), the picture signal lines are selected as in the order of Red 1 at time tₐ, Green 2 at time t_{b}, Blue 3 at time t_{c}, Red 4 at time t_{d}, Green 5 at time tₑ, and Blue 6 at time t_{f}, where at any moment of the selection, the polarity is also concurrently reversed at the moments indicated above.

In the next frame (n+1), the picture signal lines are selected as in the order of Red 1 at time t_{g}, Green 2 at time tₕ, Blue 3 at time tⱼ, Red 4 at time tₖ, Green 5 at time tₗ, and Blue 6 at time tₘ, where at any moment of the selection, the polarity is also reversed.

As can be recognized, the column selections in the frame (n) and the frame (n+1) are fulfilled in the same order.

As to the line Red 1, the polarity reversal in the adjacent picture signal line Green 2 at time t_{b} gives an effect of coupling to the capacitance to result in the voltage level dropping by one step. The polarity reversal in the line Blue 6 at time t_{f} further reduces the voltage level, and thus, the total two-step drop is observed. Such a reduction of the voltage level eventually causes the development of the color red in the field. As for the remaining picture signal lines, the similar variation of the voltage level is recognized, but at most one-step drop or even minor as will be recognized in FIG. 5.

Similarly, in the frame (n+1) where the alternate columns assume reversed polarities, the polarity reversal in the picture signal line Green 2 at time t₃ and in the picture signal line Blue 6 at time t₄, respectively, results in the voltage level rising by two steps to cause the color red accordingly as much to be developed. In the remaining picture signal lines of other colors, there arise adverse effects of the polarity reversal at the adjacent electrodes, but any variation in the voltage level will not exceed as much as two steps.

Assuming that such two-step level variation is expressed by ‘2’ while the single step level variation is ‘1’, the residual level variations for six of the column electrodes can be expressed in a sequence as (2, 1, 1, 1, 1, 0) in both the frame (n) and the frame (n+1). Consequently, red strips are more striking than others in the resultant frame picture, which causes the artifact of the red stripes in the field to significantly degrade the quality of the picture.

The present invention is advantageous to eliminate the striped artifact developed in the aforementioned manner.

FIG. 6 is a timing chart illustrating the column selection signals controlled in an application according to the present invention, which denote the order of selecting the column electrodes in both the frame (n) and the subsequent frame (n+1). Such column selection signals are generated by the column selection circuit 50 under the control of the timing control circuit 30 as shown in FIG. 1.

In the frame (n), unlike the example depicted in FIG. 4, any column adjacent to the reference is skipped. Specifically, the column selection signals are produced sequentially subsequent to S_{sw1} as in the order of S_{sw3}, S_{sw5}, S_{sw2}, S_{sw4} and S_{sw6}, namely, in the sequence of every other signal. Corresponding to this sequence of the selection signals, the column driving signal D is produced in series as in S₁, S₃, S₅, S₂, S₄ and S₆.

In the subsequent frame (n+1), however, the column selection signals and the column driving signals are produced in a different order from that in the frame (n). More specifically, the column selection signals are generated in the order of S_{sw2}, S_{sw4}, S_{sw6}, S_{sw1}, S_{sw3}, and S_{sw5}, and corresponding to this sequence of the selection signals, the column driving signal D is produced in series as in S₂, S₄, S₆, S₁, S₃ and S₅.

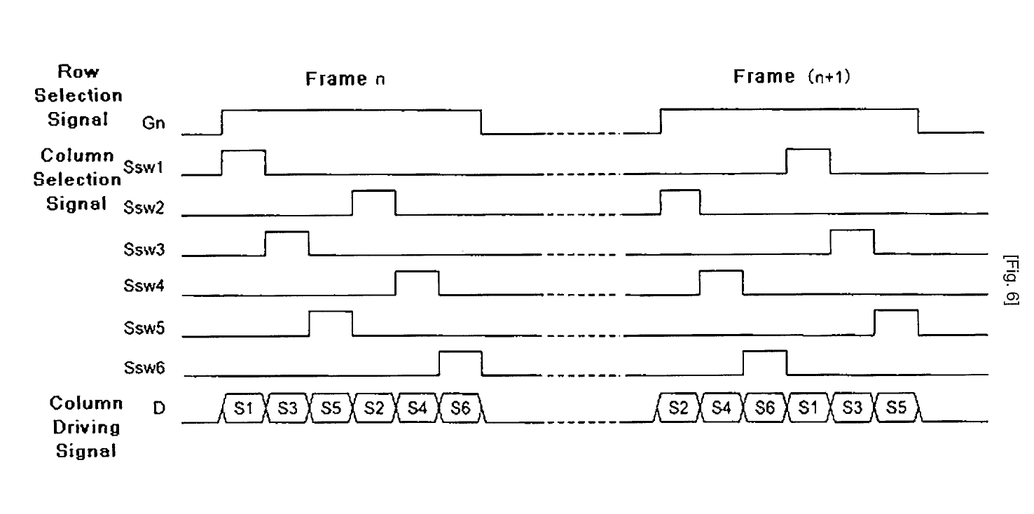

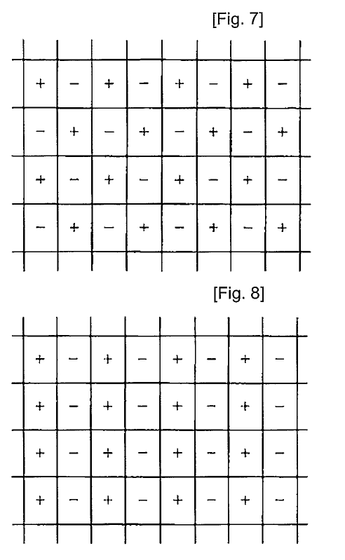

The polarity of the signal data applied to the selected picture signal lines are reversed in the frame (n) to that in the frame (n+1). FIGS. 7 and 8 show examples of the polarity reversal of the signal data where the preceding and succeeding frames are lined in the lateral directions while the columns are juxtaposed in the longitudinal directions. As can be seen, FIG. 7 depicts a case where as the current frame is replaced with the next, the polarity is necessarily reversed, but any pair of the adjacent columns have their respective polarities inverted to each other while FIG. 8 shows the polarity is consistent throughout the columns within the identical frame.

In this way, the previously selected group of the picture signal lines, once supplied with voltage, will not be affected by the coupling to the parasitic capacitance to vary from the existing potential upon the voltage supply to the picture signal lines orthogonal to those lines, unlike the prior art embodiment, and the subsequently selected group of the picture signal lines, after fully supplied with voltage, have their pixel potentials assuredly fixed at the end of selecting the scan lines of the pixels orthogonal to that group of the picture signal lines.

As in this embodiment, the order of selecting the signal sets or the signal line groups is varied from one frame to another in the present invention, and moreover, the order can be varied from one column to another, or otherwise, may be varied from one column to another and between the two consecutive frames. In either case, the required time from the previous selection of the picture signal lines to the activation of those selected next can be averaged, and, the operation efficiency, as a whole, can be enhanced.

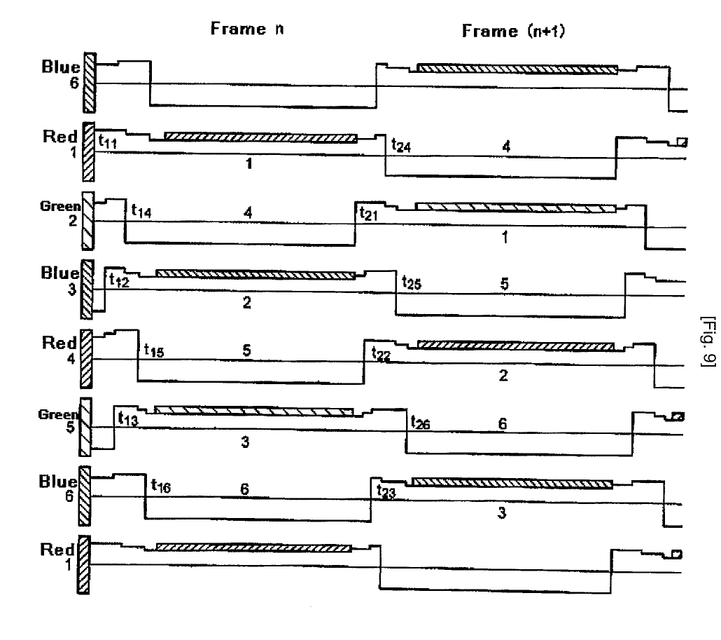

FIG. 9 is a graph illustrating a potential variation in the six picture signal lines, Red 1 through Blue 6, as in FIG. 5, under the control by the column selection signals in the application according to the present invention as shown in FIG. 6.

In some frame (n), after the picture signal is selected as in the sequence of Red 1 at time t₁₁, Blue 3 at time t₁₂, and Green 5 at time t₁₃, the polarity is reversed in the picture signal lines of Green 2 at time t₁₄, Red 4 at time t₁₅, and Blue 6 at time t₁₆, respectively. As a consequence, the potential variation in the adjacent picture signal lines and the coupling to the parasitic capacitor result in the voltage level at the picture signal lines of Red 1, Blue 3 and Green 5 dropping by two steps. Corresponding to the voltage drop as much as the two steps, there arises the artifact of stripes of the colors of red, blue and green. The residual level variation can be expressed by (2, 0, 2, 0, 2, 0) as in the similar samples shown in FIG. 5.

In the subsequent frame (n+1), the selection of the column electrodes is carried out as in the sequence of Green 2 at time t₂₁, Red 4 at time t₂₂, Blue 6 at time t₂₃, Red 4 at time t₂₄, Blue 3 at time t₂₅, and Green 5 at time t₂₆, and the level drop is caused as much as two steps, which develops the artifact of the stripes of the colors of red, green and blue, respectively. The stripes can be expressed by using the residual level variation in the picture signal lines as in (0, 2, 0, 2, 0, 2).

Since the frame (n) and the frame (n+1) are consecutive with each other, however, viewing over both the frames leads to the perception that there are developed the stripes of the same level for any corresponding columns in the frames, and they, as a whole, assume the color of gray which is invisible as the artifact.

When the adjacent signal lines are supplied with signals of the reversed polarities to each other, the method according to the present invention needs the switching of the polarity at the picture signal lines only twice during the single horizontal scan period, compared with the operation relying the sequential selection of the picture signal lines, and this effectively saves the power consumption.

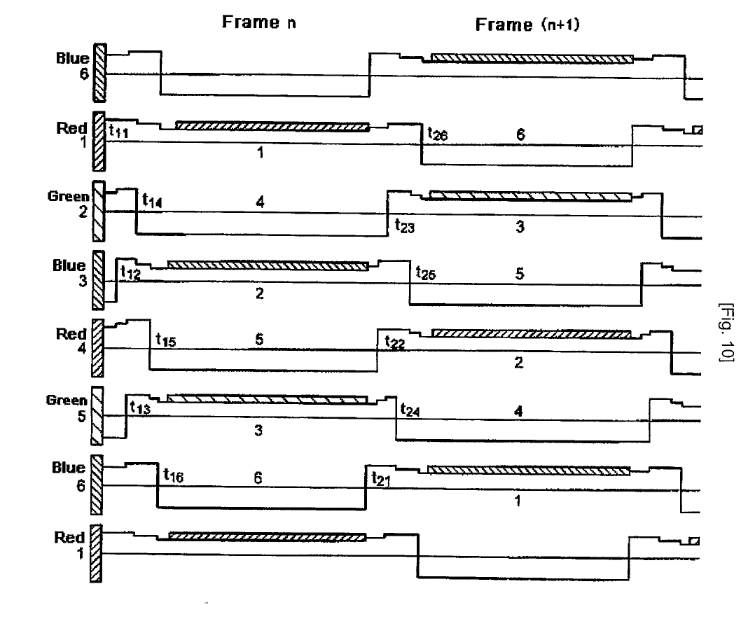

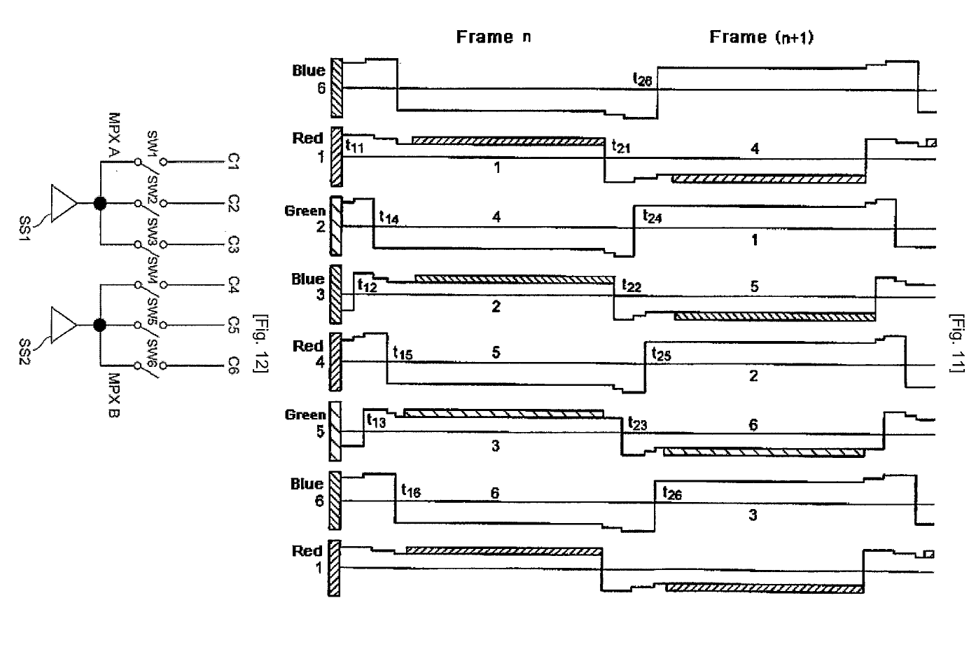

FIGS. 10 and 11 are graphs illustrating the operation in another application of the present invention.

In FIG. 10, the column selection and the polarity reversal in the first half of the frame (n) is completely the same as that of FIG. 9 where the stripes are expressed by the residual level variations at the picture signal lines as in (2, 0, 2, 0, 2, 0).

On the other hand, the column selection in the second half of the frame (n+1) is completely reversed in the order to that in the first half of the frame (n). For instance, the picture signal line is selected in the sequence of Blue 6 at time t₂₁, Red 4 at time t₂₂, Green 2 at time t₂₃, Green 5 at time t₂₄, Blue 3 at time t₂₅, and Red 1 at time t₂₆, one after another. In this case, also, as in FIG. 9, the level drop as much as two steps is developed at the picture signal lines of Green 2, Red 4, and Blue 6, respectively, and this resultantly causes the artifact of the stripes of the colors as expressed by (0, 2, 0, 2, 0, 2). Thus, viewing over both the frames leads to a perception that the artifact is invisible.

As has been described, in the embodiments shown in FIGS. 9 and 10, the control is carried out on the single frame basis, but an additional embodiment provides another control method in which the control is performed on the double frame basis.

Referring to FIG. 11, the column selection and the polarity reversal in the first half of the frame (n) is completely the same as in FIG. 9 where the stripes are observed due to the residual level variations at the picture signal lines as expressed in (2, 0, 2, 0, 2, 0).

The polarity reversal during the transition from the frame (n) to the frame (n+1) is different from that of FIG. 9 where the potential is raised directly from the level upon the polarity reversal without returning to the reference level in the course. Thus, in this embodiment, when the polarity is first reversed and then a rise of the voltage level in the future is predictable, the voltage is compensated for an increase as much as the predicted rise, and instead, the bottom level is raised.

Specifically, as to the picture signal line of Green 2, upon the polarity reversal, the inherent low potential is further dropped by two steps due to the effect of the other picture signal line(s). Although its potential is normally raised to the predetermined positive level, the potential at the picture signal line is expected to raise its level twice due to the polarity reversal in the adjacent picture signal line(s) in the future, and therefore, a potential increase as much as the predicted rise needs not to be raised. Thus, the potential is raised to the level two-step lower than the inherent peak level. Such circumstances occur in common for the picture signal lines of Red 4 and Blue 6. The bottom level at the picture signal lines of Red 1, Blue 3 and Green 5 is gradually raised due to the polarity reversal in the adjacent picture signal line(s), and a potential increase as much as the rise by two steps causes the stripes for each color. As the polarity of the stripes is negative, the residual level variation can be expressed by (−2, 0, −2, 0, −2, 0).

Thus, the stripes derived from the picture signal lines of Red 1, Blue 3 and Green 5 for two cycles (n) and (n+1) countervail one another, and the striped artifact is not observed.

In this embodiment, the potential variation in the future is preliminarily counted in to raise the potential to a level as satisfied after the polarity reversal, and hence, the power consumption can be reduced.

In the aforementioned embodiment, since the field essentially consists of three colors, the column electrodes as many as multiples of three can be selected (e.g., six of the columns), but the number of colors may be optionally increased or decreased although sets of the columns subjected to the selection must be even in number.

Furthermore, although the columns of the electrodes can be selected so that more than one columns are permitted to selectively connect with the picture signal lines in the aforementioned embodiment according to the present invention, rows of the electrodes instead of the columns may be selected in some construction of the display device so as to selectively connect more than one rows to the picture signal lines.

Although the column selection is carried out for each unit period of the horizontal scanning, the vertical period may be the alternative to the unit period.

When one frame is read out in the sequence different from that in another frame, various orders can be contemplated as well as the sequence described in the embodiments.

The present invention can also be applied to active matrix liquid crystal display devices activated on the basis of row-to-row reversed polarity in addition to those activated on the basis of column-to-column reversed polarity in order to attain the similar effects of saving the supplied power of the picture signal source and stably providing quality pictures. The present invention can be further applied to active matrix liquid crystal display device activated on the basis of both the row-to-row polarity reversal and the frame-to-frame polarity reversal so as similarly to stably provide quality pictures.

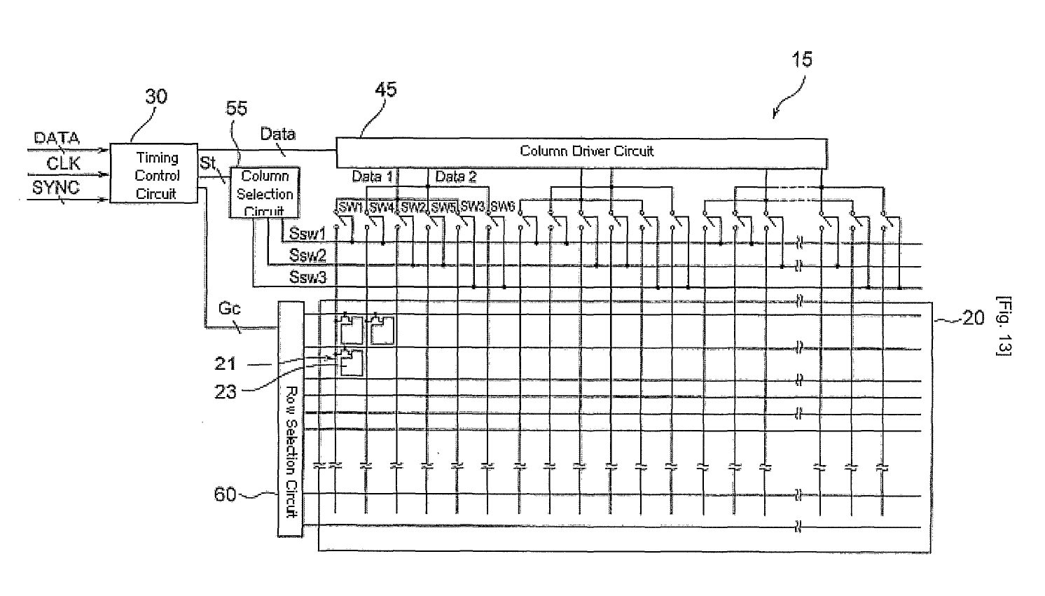

Referring to FIG. 13 to FIG. 15, further embodiment of the present invention will be described.

FIG. 13 is a schematic block diagram similar to FIG. 1, and the diagram depicts a configuration of an exemplary liquid crystal display apparatus 15 according to the present invention, including active matrix driver circuits.

FIG. 13 is different from FIG. 1 in that the former includes a selective control unit that serves to make the column driver circuit 45 and the column selection circuit 55 supply the picture signals produced therefrom to the picture signal lines selected by the column selection circuit 55. Specifically, the embodiment in FIG. 12 has different features that two picture signals Data1 and Data2 for six columns of the pixels are transferred from the column driver circuit 45 to the selective control unit and that three selection signals S_{SW}1 to S_{SW}3 are produced from the column selection circuit 55 to the selective control unit.

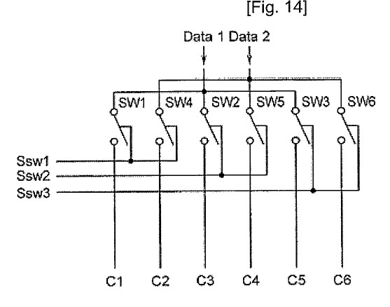

FIG. 14 is a schematic circuit diagram showing a configuration of the selective control unit that characterizes this embodiment and is provided in contrast with FIG. 12, and FIG. 14 is depicted upside down compared with FIG. 12 for the purpose of coherence with FIG. 13.

In this embodiment, two of the multiplexers together serve as a primary part as in the embodiment in FIG. 12, and the picture signal lines connected to their corresponding one of the switches are arranged adjacent to one another. Specifically, similar to the case in FIG. 12, a first multiplexer MPXA has selecting switches SW1 to SW3 while a second multiplexer MPXB has selecting switches SW4 to SW6, each of the multiplexers has its input supplied with the picture signal Data1 from the first picture signal source in the column driver circuit 45 and also with the picture signal Data2 from the second picture signal source of the same. The selecting switches are arranged in the order as numbered and alternately between two groups of the switches for both the multiplexers; that is, the first switch SW1 of the first multiplexer is adjacent to the first switch SW4 of the second multiplexer, and so forth. The picture signal lines C1 to C6 are connected in series to switches in parallel with one another in the order as numbered.

On the other hand, ones of the selecting switches for both of the multiplexers, which are related to a specific pair of the adjacent picture signal lines, are turned simultaneously on and off by the column selection circuit 55. For instance, the switch SW1 associated with the picture signal line C1 and the switch SW4 associated with the picture signal line C2 adjacent to the signal line C1 are turned simultaneously on and off based on a shared selecting signal S_{SW}1, and the remaining switches are connected in the similar operative manner.

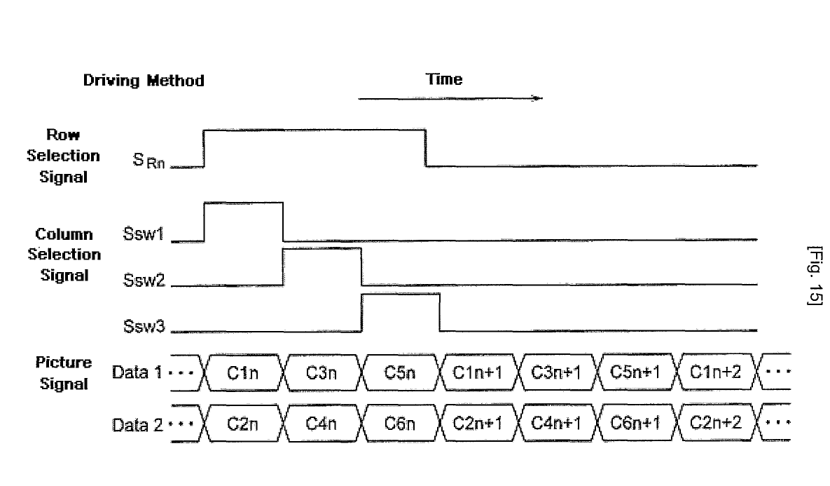

FIG. 15 shows the operation as explained above where the picture signals are supplied to the picture signal lines selected by the column selection circuit 55 while a row selection signal S_{Rn} produced from the row selection circuit 45. Thus, during the first column selection period, the selecting signal S_{SW}1 causes the switches SW1 and SW4 to turn simultaneously off so as to make the picture signal sources to supply picture signals C1n and C2n to the picture signal lines C1 and C2, respectively.

During the subsequent column selection period, the switches SW1 and SW2 are turned off while the selection signal S_{SW}2 causes the switches SW2 and SW5 to turn simultaneously on so as to make the picture signal sources supply picture signals C3n and C4n to the picture signal liens C3 and C4, respectively. The similar sequence is applied to each of the remaining pairs of the adjacent picture signal lines to produce picture signals thereto.

With such control, the adjacent picture signal lines in pair are simultaneously selected and simultaneously varied in state, and hence, no coupling loss is observed between the adjacent picture signal lines.

On the other hand, there arises the coupling loss between the adjacent picture signal lines respectively activated during different selection periods, and this brings about two types of signal line pairs at the same time in the single circuitry; that is, the ones that would not cause such coupling loss and the ones that would cause the coupling loss. During a single scanning period of time. However, such loss is theoretically identical in amount for any bus pair so that no level shift is caused as observed in the prior art as a transient between two levels.

Applying the configuration of this embodiment to the following execution sequence can attain the similar effects.

In this case, producing the selection signals S_{SW}1, S_{SW}2, and S_{SW}3 simultaneously from the column selection circuit permits all the selecting switches SW1 to SW6 for both the multiplexers to turn on at the same time so as to energize all the picture signal lines and convert their polarity into the writable or their voltage level to the ground potential in advance, and subsequently, the switches are sequentially turned off, starting with opening the switches SW1 and SW2.

With the execution in such a manner, all the data lines are energized to reach the approximate targeted level of voltage in advance, and an instantaneous inspection proves that the voltage variation due to the capacity coupling is reduced to a half while an additional inspection for a single frame gives a level equivalent to a root-mean-square (rms) value. In this way, the level variation can be more effectively restricted.

In another case, a possible application to the execution sequence is as follows.

In this case, a selecting time for each bus is determined depending upon the number of buses that are to be activated simultaneously. Specifically, a period of time for which all the buses are being selected is several times as long as the time spent to select only a single bus.

With the execution in such a manner, the amplifier as a whole can reduce its driving power, and this leads to a reduction of the total power consumption.

As has been described, this embodiment using the multiplexers to selectively activate specific pairs of the adjacent picture signal lines can restrict color variations especially in the intermediate gradation that is caused by the voltage level variations due to the coupling of the adjacent buses in the prior art circuit configuration when those buses are in their respective floating conditions. It is especially noted that even if the adjacent buses are activated at the reversed polarity, such reduction of the voltage level can be attained.

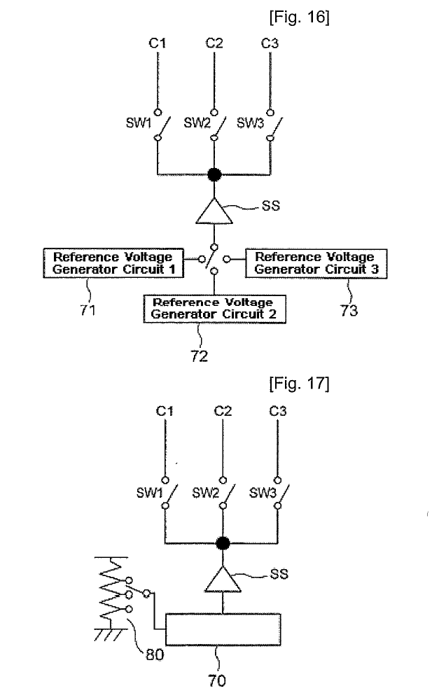

FIGS. 16 and 17 are schematic diagrams showing a structure for compensating potential related problems caused during the scanning period of time.

As has been described in the case particularly allowing for three of the picture signal lines C1 to C3, the switches SW1 to SW3 associated with the picture signal lines are sequentially selected during the scanning period of time, and upon receiving data from the picture signal sources, a coupling capacity between the adjacent pixels and signal liens results in the potential being varied from one picture signal line to another, despite the identical voltage supply, as denoted by the relation as Vc3>Vc2>Vc1.

Therefore, in this case, it is devised that the voltage compensating for the known potential variations is applied to the picture signal source.

In FIG. 16, a potential supplied to the picture signal source SS is shifted by switching among three reference voltage generator circuits 71 to 73 depending upon which one is selected in the selection switches SW1 to SW3. In this embodiment, the reference voltage generator circuit (1) used upon selecting the switch SW1 produces the highest voltage Vr1 while the reference voltage generator circuit (3) used upon selecting the switch SW3 produces the lowest voltage Vr3. Specifically, the switches are selected so that the resultant voltages are correlated as in Vr1>Vr2>Vr3.

Configured in this way, the potential of the picture signal lines can be prevented from varying during the operation so as to enable more accurate signal detections, and thus, the resultant picture can be enhanced in quality.

FIG. 17 shows a more simplified embodiment than that in FIG. 16, and a resistance divider 80 is provided to serve as a source of three reference potentials that are produced by a reference voltage generator circuit 70 in the subsequent stage of the circuit.

In this case, also, the potential of the picture signal lines can be prevented from varying so as to attain the enhanced quality of the picture.

### EXPLANATIONS OF REFERENCE NUMERALS

10 active matrix type liquid crystal display device
20 display panel
21 TFT
23 pixel electrode
30 timing control circuit
40, 45 column driver circuit
50, 55 column selection circuit
60 row selection circuit

1. An active matrix liquid crystal display device having a plurality of picture signal lines and a plurality of scan lines orthogonal to them, and a plurality of pixels arranged in matrix form and connected to the picture signal lines by switching elements intervening between them, comprising:
selection switches provided in the plurality of the picture signal lines on a substrate constituting a display device;
a plurality of picture signal sources smaller than the picture signal lines in number; and
a selective control device capable of selectively opening/closing the selection switches to skip connection with any picture signal line adjacent to each other, in the case that the plurality of picture signal sources are shared by the plurality of picture signal lines.

2. The active matrix liquid crystal display device as claimed in claim 1, wherein the picture signal lines are divided into even number of groups including two groups such as a first group of every other picture signal lines selected at first by skipping manner and a second group of the remaining picture signal lines subsequently selected, and the selective control device selects the first group and the second group by this order.

3. The active matrix liquid crystal display device as claimed in claim 2, wherein the first group of the picture signal lines belonging to all the picture signal lines of odd number while the second group of the picture signal lines belonging to the even number, or vice versa.

4. The active matrix liquid crystal display device as claimed in claim 2 or 3, wherein the selective control device selects in a way that for a predetermined period of time, it selects the first group first, then the second group, and for the succeeding period of time, it selects the second group first, then the first group.

5. The active matrix liquid crystal display device as claimed in claim 2 or 3, wherein the selective control device selects in a way that for a predetermined period of time, it selects the first group first, then the second group, and for the succeeding period of time, it selects the second group first in the reversed order of the picture signal lines, then the first group in the reversed order of the picture signal lines.

6. The active matrix liquid crystal display device as claimed in claim 4 or 5, wherein for the succeeding period of time, the picture signal sources invert the polarity of signals supplied to the picture signal lines at the predetermined period of time, and compensate the supplied signals for a predictable level variation in the future.

7. A method of driving an active matrix liquid crystal display device which is comprised of an active matrix liquid crystal display panel having a plurality of picture signal lines and a plurality of scan lines orthogonal to them, and a plurality of pixels in matrix and connected to the lines by switching elements intervening between them; selection switches provided in the plurality of the picture signal lines on a substrate constituting a display device; and a plurality of picture signal source smaller than the picture signal lines in number;
the method comprising the step of:
selectively opening/closing the selection switches to skip connection with any picture signal line adjacent to each other, in the case that the plurality of picture signal sources are shared by the plurality of picture signal lines.

8. The method as claimed in claim 7, further comprising the step of: dividing the plurality of the picture signal lines into even number of groups including two groups such as a first group of every other picture signal lines selected at first by skipping manner and a second group of the remaining picture signal lines subsequently selected, and selecting the first group and the second group by this order.

9. The method as claimed in claim 8, wherein the first group of the picture signal lines belonging to the picture signal lines of odd number while the second group of the picture signal lines belonging to the even number, or vice versa.

10. The method as claimed in claim 8 or 9, further comprising the step of selecting in a way that for a predetermined period of time, the selective control device selects the first group first, then the second group, and for the succeeding period of time, it selects the second group first, then the first group.

11. The method as claimed in claim 8 or 9, further comprising the step of selecting in a way that for a predetermined period of time, the selective control device selects the first group first, then the second group, and for the succeeding period of time, it selects the second group first in the reversed order of the picture signal lines, then the first group in the reversed order of the picture signal lines.

12. The method as claimed in claim 10 or 11, further comprising the steps of, for the succeeding period of time, inverting the polarity of the picture signal sources at the predetermined period of time, and compensating the supplied signals for a predictable level variation in the future.

13. An active matrix liquid crystal display device comprised of a plurality of picture signal lines and a plurality of scan lines orthogonal to them, and a plurality of pixels arranged in matrix form and connected to the lines by switching elements intervening between them, comprising
selection switches respectively provided with the plurality of the picture signal lines on a substrate constituting a display device;
a plurality of picture signal source producing picture signals and smaller than the picture signal lines in number; and
a plurality of picture signal selecting circuits selecting a single picture signal line in one of groups of the picture signal lines and supplying picture signals from the picture signal sources on the time-sharing basis to the selected picture signal line;
the picture signal lines, which are simultaneously selected respectively by the picture signal selecting circuits, being arranged adjacent to one another.

14. The active matrix liquid crystal display device as claimed in claim 13, wherein each of the picture signal selecting circuits includes a plurality of multiplexers with selecting switches associated with a plurality of groups of the picture signal lines which are not simultaneously selected by the picture signal selecting circuits.

15. The active matrix liquid crystal display device as claimed in claim 13, wherein said plurality of the picture signal selecting circuits control corresponding single picture signal line in the groups of the picture signal lines simultaneously.

16. The active matrix liquid crystal display device as claimed in claim 1 or 13, further comprising a reference voltage generator circuit capable of compensating reference voltage of the picture signal sources so as to keep the picture signal lines constant in potential after convergence of the potential levels over the scanning period of time.

17. The active matrix liquid crystal display device as claimed in claim 16, wherein the reference voltage generator circuit includes a plurality of voltage sources generating various reference voltages.

18. The active matrix liquid crystal display device as claimed in claim 16, wherein the reference voltage generator circuit is comprised of a potential divider capable of generating a plurality of reference voltages.

19. In a method of driving an active matrix liquid crystal display device comprised of a plurality of picture signal lines and a plurality of scan lines orthogonal to them, an active matrix liquid crystal display panel including a plurality of pixels arranged in matrix from and connected to the lines by switching elements intervening between them, selection switches respectively provided with the plurality of the picture signal lines on a substrate constituting a display device and a plurality of picture signal sources producing picture signals and smaller than the picture signal lines in number,
when the plurality of picture signal sources are shared among the plurality of the picture signal lines, corresponding selecting switches in adjacent picture signal lines to which the picture signal are provided by the picture signal sources are simultaneously selected.

20. The method as claimed in claim 19, wherein before initiating the scanning, the selecting switches associated with all the picture signal lines are selected and then all the picture signal lines are charged to reach a predetermined data level in advance, and then, the selecting switch associated with the specific pair of the adjacent picture signal lines are sequentially turned off.

21. The method as claimed in claim 20, wherein the driving time of the picture signal lines is determined depending upon the number of the picture signal lines activated simultaneously.
